(19) United States
(12) Patent Application Publication
(10) Pub. No.: US 2004/0194876 A1
(43) Pub. Date: Oct. 7, 2004

(54) Method for connecting microchip modules to antennas, which are placed on a first supporting strip, in order to produce a transponder

(76) Inventors: Ludger Overmeyer, Bordenau (DE); Peter Giegerich, Munchen (DE); Michael Deppe, Munchen (DE)

Correspondence Address: Timothy E Newholm, Boyle Fredrickson Newholm Stein & Gratz, 250 Plaza Suite 1030, 250 East Wisconsin Avenue, Milwaukee, WI, 53202, US

(21) Appl. No.: 10/485,055

(22) PCT Filed: Jun. 11, 2002
(86) PCT No.: PCT/EP02/06408

(30) Foreign Application Priority Data
Jul. 26, 2001 (DE) 101 36 359.1

(51) Int. Cl. G06K 19/077; B32B 31/00; B44C 1/165

(52) U.S. Cl. 156/230; 156/235; 156/239

(57) ABSTRACT

The invention relates to a method for the connection of micro-chip modules to antennas arranged on a first carrier tape for the manufacture of a transponder, in which the chip modules are first applied to a second carrier tape and both carrier tapes are wound off the reel and brought one above the other, whereby the chip modules are released from the second carrier tape and placed at a predetermined point on the first carrier tape. Release is implemented in a simple manner in that the second carrier tape is diverted at a sharp edge and peels off the back of the chip module.

The invention relates to a method for the connection of micro-chip modules to antennas arranged on a first carrier tape for the manufacture of a transponder, in which the chip modules are first applied to a second carrier tape and both carrier tapes are wound continuously off the reel and brought one above the other, whereby the chip modules are released from the second carrier tape and placed at a predetermined point on the first carrier tape.

This type of method is described in the German patent application 10120269 which has not yet been published. With the method described in that patent application, the chip modules are passed around a diversion roller which can be heated, whereby the adhesive forces of the glue holding the chip modules on the second carrier tape are neutralised. The chip module released in this way is fixed by a transport tape circulating in synchronism with the first carrier tape and is passed to the following crimping or soldering stations.

The object of this invention is to further improve the method described at the beginning. This object is solved in that the release of the chip modules from the second carrier tape occurs in that the carrier tape is diverted around an edge. Here, use is made of the fact that the second carrier tape, normally a foil, is very flexible, whereas the chip module exhibits a certain stiffness. Diversion of the carrier tape around an edge causes the carrier tape to peel off the chip module.

This peeling process can be preferably promoted in that the carrier tape is heated in the region of the release point and/or in that the diversion edge is sharp-edged. Both measures promote the release process.

According to an advantageous embodiment of the invention the chip module released in this manner is taken by a holder device which places the chip module onto the first carrier tape and which moves the chip module in synchronism to the first carrier tape, at least at the time of the chip module placement. In this respect, a holding device is particularly preferable which exhibits a rocker, driven by a crank mechanism, with a fixing stamp which places the released chip module onto the first carrier tape. The crank mechanism driving the rocker can be easily synchronised to the first carrier tape so that at the time of the chip module placement onto the terminals of the appropriate antenna, the chip module is moved at the same speed as the first carrier tape.

The placement and fixing of the chip module on the first carrier tape can be simply achieved in that the chip module is stuck onto the first carrier tape using the fixing stamp. Here, use is made of the fact that the chip module is in any case fitted with an adhesive foil.

Alternatively, the chip module can however also be crimped onto the carrier tape using the fixing stamp, whereby the electrical connections to the antenna are simultaneously provided by this crimping process. In this respect it is convenient if the holder device exhibits a double rocker with fixing stamps arranged as a pair on both sides of the first carrier tape. The two fixing stamps, arranged as a pair, can form the crimping station in this way, whereby one stamp represents the tool and the other fixing stamp the opposing fixture.

Another way of synchronously driving the holder device can preferably be provided in that the holder device can be joined for part of the time to the first carrier tape. This can occur, for example, through a clutch which frictionally connects the holder device with the first carrier tape. When the fixing process has terminated, the clutch is released again so that the holder device can be returned to its initial position, for example, by a spring device.

In the following an embodiment of the invention is explained in more detail based on a drawing.

The following are shown:

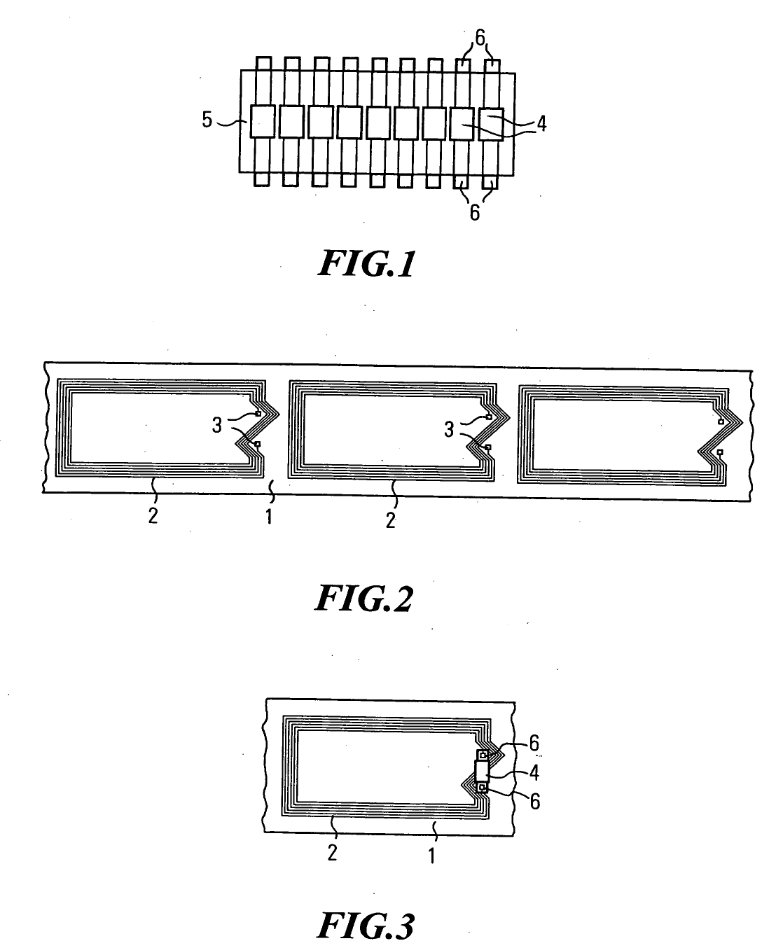

FIG. 1 shows a first carrier tape fitted with antennas;

FIG. 2 shows a second carrier tape fitted with chip modules;

FIG. 3 shows the first carrier tape from FIG. 1 with placed chip modules connected to the antenna terminals;

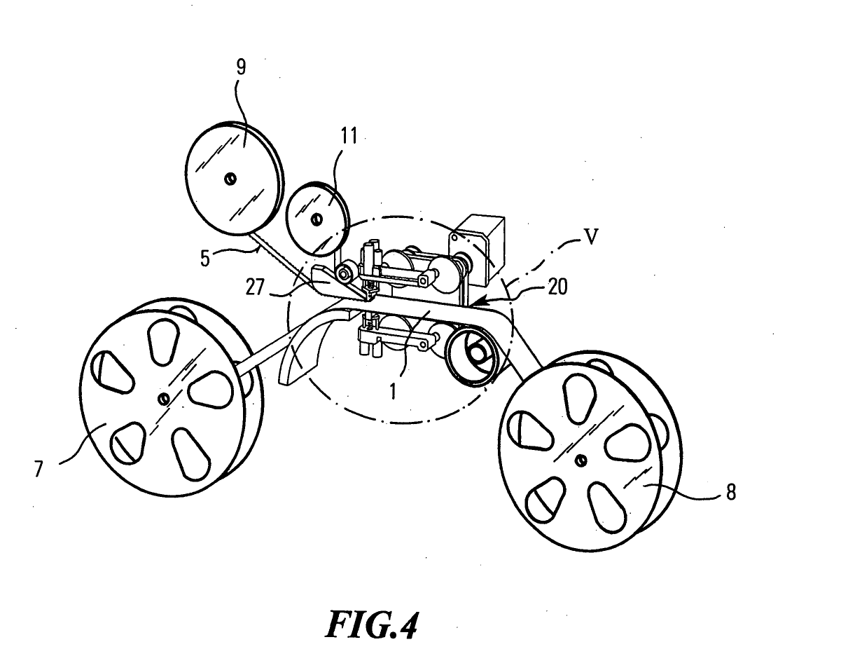

FIG. 4 shows in a schematic representation a device for the connection of the chip modules on the second carrier tape to the antennas on the first carrier tape; and

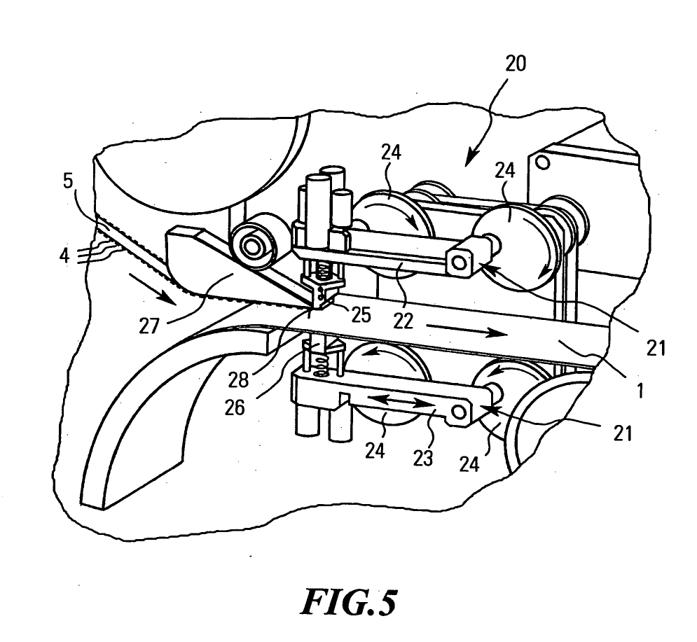

FIG. 5 shows a detail view V of the device in FIG. 4.

FIG. 1 shows a first carrier tape I on which coils 2 have been applied as antennas. Here, the antennas have been manufactured by deposition during electroplating. The coils 2 exhibit two terminals 3 for a chip module.

This type of chip module 4 is shown in FIG. 2. They are held closely one behind the other on a second carrier tape 5. The chip modules are packaged into a chip case shown in FIG. 2 by a preceding bonding process. This case exhibits two terminal pads 6 which are already tinned and which have a spacing corresponding to the terminals of the rectangular coils 2.

FIG. 3 shows a carrier tape 1 with a rectangular coil 2 which has already been complemented with a chip module 4. The chip module 4 has been soldered to the terminals 3 by its terminal pads 6.

In the following the manufacturing method is explained in more detail based on FIGS. 4 and 5. The first carrier tape 1 carrying the antenna coils 2 is rolled up onto an antenna reel 7 and is unwound from it and after the connection process it is wound up onto an antenna finish reel 8.

The second carrier tape 5 carrying the chip modules 4 is unwound from a reel 9 and wound up onto a second reel 11.

A holder device 20 is provided between the antenna input reel 7 and the antenna finish reel 8. This holder device 20, which can be seen in more detail in FIG. 5, comprises a double rocker 21 with an upper rocker arm 22 and a lower rocker arm 23. Both rocker arms are driven by a crank mechanism, here comprising four cranks 24 and they execute to and fro movements which are synchronised to the speed of the first carrier tape. Both rocker arms 22 and 23 each carry a fixing stamp 25, resp. 26, whereby the upper fixing stamp 25 is formed as a crimping tool, while the lower fixing stamp 26 forms the corresponding opposing fixture. Directly in front of the fixing stamps a diversion wedge is provided for the second carrier tape 5. The diversion wedge 27 has a sharp front edge 28 over which the second carrier tape 5 is diverted so that it is released from the chip module 4.

Having described the construction of the device, its method of operation will now be explained in more detail.

The antenna tape 1, that is the first carrier tape, is continuously unwound from the antenna input reel 7 and wound onto the antenna finish reel 8. The drive of the reels 9 and 11 for the second carrier tape 5 is provided via an indexer and is therefore intermittent. As can be very well seen in FIG. 5, the carrier tape 5 carrying the chip modules 4 is passed over the underside of the diversion wedge 27 and in such a manner that the carrier tape faces the wedge, whereas the chip modules face the upper side of the first carrier tape 1. The carrier tape 5 is diverted at the sharp edge 28, so that the carrier tape is released from the chip modules 4. The chip modules released in this manner are pressed by the fixing stamp 25 onto the carrier tape 1 which is supported by the fixing stamp 26 arranged on the underside. With the preferred embodiment illustrated here, fixing is implemented by sticking the chip module to the carrier tape and by simultaneous crimping of the terminals 6 of the chip modules 4 to the terminals 3 of the antennas 2. Sticking here is quite simply achieved in that adhesive foils, which can be thermally activated, are applied to the side of the chip module facing away from the carrier tape 5, the adhesive foils being fixed onto the first carrier tape by the fixing stamp which can be heated. During the sticking and crimping process the holder device 20, or more precisely its double rocker 21, is moved via the crank 24 synchronously and at the same speed as the carrier tape 1, so that no relative movement takes place between the chip module 4 and carrier tape 1. Once crimping is complete, the fixing stamps 25 and 26 are released from the carrier tape 1 and are brought into their initial position by the rocker arms 22 and 23.

The synchronisation between the holder device 20 and the carrier tape 1 can occur by electronic means via sensors and following electrical drives.

Although the embodiment described above is preferred, it is also conceivable that sticking and crimping can take place in consecutively positioned, separate stations. Since the chip modules are already fixed during the crimping process due to the preceding adhesion stage, then during the crimping process a moving opposing fixture can be omitted if necessary.

1. A method of connecting micro-chip modules to antennas arranged on a first carrier tape for the manufacture of a transponder, with which the chip modules are applied to a second carrier tape and both carrier tapes are unwound from the reel and brought one over the other, whereby the chip modules are released from the second carrier tape and placed at a predetermined point on the first carrier tape, wherein the release of the chip modules from the second carrier tape occurs in that the carrier tape is diverted around an edged.

2. A method according to claim 1, wherein the diversion edge is sharp-edged.

3. A method according to claim 1, wherein the release of the chip modules from the second carrier tape occurs in that the carrier tape is heated in the region of the release point.

4. A method according to claims 1, wherein the released chip module is taken by a holder device which places the chip module onto the first carrier tape and which, at least at the time of placement of the chip module, moves synchronously with the first carrier tape.

5. A method according to claims 4, wherein the holder device exhibits a rocker driven by a crank mechanism (cranks) and having a fixing stamp, in which the chip module is fixed to the first carrier tape.

6. A method according to claims 5, wherein the chip module is stuck to the first carrier tape using the fixing stamp.

7. A method according to claims 5, wherein the chip module is crimped onto the first carrier tape using the fixing stamp with simultaneous joining of the electrical connection to the antenna.

8. A method according to claims 4, wherein the holder device exhibits a double rocker with fixing stamps arranged as a pair on both sides of the first carrier tape.

9. A method according to claims 4, wherein the holder device can be connected intermittently to the first carrier tape for the synchronous drive of the holder device.

10. A method according to claims 4, wherein the holder device can be returned to its initial position by a spring device.

11. A device for carrying out the method according to claims 1, with an antenna input reel and an antenna finish reel and with a reel for the carrier tape exhibiting the chip modules and a reel for winding up the empty second carrier tape, with a holder device arranged between the antenna input reel and the antenna finish reel for the chip module to be placed appropriately and with a diversion edge for the second carrier tape directly in front of the holder device.

12. A device according to claim 11, wherein the holder device exhibits a fixing stamp for sticking and/or crimping the chip module to the first carrier tape.

13. A device according to claim 12, wherein the holder device exhibits a rocker driven by a crank mechanism (cranks) which is driven in synchronism with the first carrier tape, the rocker carrying the fixing stamp.

14. A device according to claims 12, wherein the fixing stamp can be heated and is formed as an integrated adhesion and crimping stamp.

15. A device according to claims 12, wherein the holder device is formed as a double rocker and exhibits two fixing stamps arranged as a pair on opposite sides of the first carrier tapes.

16. A method of connecting micro-chip modules to antennas for the manufacture of transponders, comprising:
unwinding first and second carrier tapes from respective reels, the first carrier tape bearing the antennas and the second carrier tape bearing the micro-chip modules;
superimposing the first and second carrier tapes and releasing the micro-chip modules from the second carrier tape at a release point and placing each of the micro-chip modules at a predetermined point on the first carrier tape, wherein the release of the micro-chip modules from the second carrier tape occurs as the second carrier tape is diverted around an edge located adjacent the first carrier tape.

17. A method according to claim 16, wherein the diversion edge is sharp-edged.

18. A method according to claim 16, further comprising, for each micro-chip module, heating the second carrier tape in the region of the release point to facilitate release of the micro-chip module from the second carrier tape.

19. A method according to claim 16, wherein, for each micro-chip module, the placing step comprises taking the released micro-chip module by a holder device and placing the micro-chip module onto the first carrier tape, the holder device moving synchronously with the first carrier tape at the time of micro-chip module placement.

20. A method according to claim 19, wherein the holder device includes 1) a rocker driven by a crank mechanism and 2) a fixing stamp via which the chip module is fixed to the first carrier tape.

21. A method according to claim 20, wherein the placing step comprises, for each micro-chip module, sticking the micro-chip module to the first carrier tape using the fixing stamp.

22. A method according to claim 20, further comprising, for each micro-chip module, crimping the micro-chip module onto the first carrier tape and simultaneously electrically connecting the micro-chip module to the associated antenna.

23. A method according to claim 19, wherein the holder device includes a double rocker with fixing stamps arranged as a pair on both sides of the first carrier tape.

24. Method according to claim 19, wherein the holder device is connected intermittently to the first carrier tape to synchronously drive the holder device with the first carrier tape.

25. A method according to claim 1, further comprising intermittently returning the holder device to an initial position thereof using a spring device.

26. A device for connecting micro-chip modules to antennas for the manufacture of transponders, comprising:
an antenna input reel configured to support a first carrier tape bearing antennas;
an antenna finish reel configured to wind up the first carrier tape as the first carrier tape is unwound from the antenna input reel;
a carrier tape reel configured to support a second carrier tape bearing micro-chip modules;
a carrier tape windup reel configured to wind up the second carrier tape after the micro-chip modules are removed therefrom; and
a holder device arranged between the antenna input reel and the antenna finish reel, the holder device having a diversion edge over which the carrier tape is configured to pass so as to release each micro-chip module from the carrier tape at a predetermined point relative to the first carrier tape.

27. A device according to claim 26, wherein the holder device includes a fixing stamp configured to at least one of stick the micro-chip modules to the first carrier tape and crimp the micro-chip modules to the first carrier tape.

28. A device according to claim 27, wherein the holder device includes a rocker driven by a crank mechanism which is driven in synchronism with the first carrier tape, the rocker carrying the fixing stamp.

29. A device according to claim 26, wherein the fixing stamp is heated and is formed as an integrated adhesion and crimping stamp.

30. A device according to claim 26, wherein the holder device is formed as a double rocker and includes two fixing stamps configured to be arranged as a pair on opposite sides of the first carrier tape.
